(19) United States
(12) Patent Application Publication
(10) Pub. No.: US 2026/0074515 A1
(43) Pub. Date: Mar. 12, 2026

(54) EMP PROTECTION SYSTEM

(71) Applicant: ENERGY RESEARCH LAB LTD, LONDON (GB)

(72) Inventor: LEE HARRISON, LONDON (GB)

(73) Assignee: ENERGY RESEARCH LAB LTD, LONDON, EN (GB)

(21) Appl. No.: 18/868,348

(22) PCT Filed: May 30, 2023
(86) PCT No.: PCT/GB2023/051421

§ 371 Date: Nov. 22, 2024

(30) Foreign Application Priority Data
May 30, 2022 (GB) 2207951.1

(51) Int. Cl. H02J 3/00; H02H 3/02; H02H 3/46; H02H 5/00

(52) U.S. Cl. CPC H02J 3/00125; H02H 3/023; H02H 3/46; H02H 5/005; H02J 3/0012

(57) ABSTRACT

An aspect of the disclosure provides a high frequency alternating current (HFAC) power distribution system configured to provide an HFAC power supply on an HFAC power supply bus to enable a plurality of electronic devices to be connected to the power supply bus for receiving HFAC electrical energy, the power distribution system comprising: an HFAC power supply configured to provide HFAC electrical energy to the HFAC power supply bus and having power supply output terminals for coupling to said bus; a protection circuit connected to the power supply and being arranged to provide a short circuit of the power supply; a power supply inhibitor operable to disable the power supply to prevent the provision of electrical energy; a detector circuit, configured to monitor gamma radiation to provide a detection signal; and a controller configured to operate the power supply inhibitor to prevent the provision of electrical energy in the event that the detection signal exceeds a threshold and then subsequently to operate the protection circuit to provide the short circuit.

### FIELD OF INVENTION

The present invention relates to methods and apparatus, and more particularly to methods and apparatus for the protection of electrical and/or electronic circuitry from damage by electromagnetic pulses.

### BACKGROUND

Electromagnetic pulse (EMP) is a force of nature that can wreak havoc with much of modern electronic infrastructure, solar storms throughout history have caused damage and outages, but events such as the Carrington event in today's highly dependent technology centric world would be devastating. In addition to the threat posed by solar EMP we have to contend with the threat of more damaging EMP events from nuclear weapons, or super EMP devices. Any nuclear weapon detonated above an altitude of 30 kilometres will generate an electromagnetic pulse that will destroy electronics and could collapse the electric power grid and other critical infrastructures, communications, transportation, banking and finance, food and water, essentials that sustain modern civilization and the lives of billions of people. All could be destroyed by a single nuclear weapon creating an EMP attack. The EMP threat extends beyond the local events. While a nuclear weapon detonated above a modern country could cause devastation, much smaller devices can use pulses of radio frequencies to damage specific targets such as, refineries, electric substations, power plants and other essential services.

Solar EMP events are generally categorised as E2 or E3 pulse events, a few devices exist in the world designed to mitigate some of the risks of these events by way of filtering incoming supply lines. The most damaging event is that of a weapon creating a very fast E1 pulse whereby the E2 and E3 pulses follow shortly afterwards.

Fundamentally, protection from high altitude explosions (HEMP) is a demanding task and only more recently gaining momentum in protecting against such events. HEMP contains E1, a short single 2-25 nS pulse creating >55 kV/m at ground level, E2, similar to EMP delivered in lightning strikes and E3, a slower oscillating frequency, typically below 0.1 Hz and lower filed strength up to 100 V/km which may last several minutes.

EMP events may induce large current spikes in electrical equipment, which can cause damage to the equipment. Existing surge protection devices may not be capable of protecting all types of equipment and may not be effective at all against EMP events.

### SUMMARY

Aspects and examples of the present disclosure are set out in the claims and aim to address at least a part of the above technical problem, and other problems.

In an aspect there is provided a high frequency alternating current (HFAC) power distribution system configured to provide an HFAC power supply on an HFAC power supply bus to enable a plurality of electronic devices to be connected to the power supply bus for receiving HFAC electrical energy, the power distribution system comprising:
an HFAC power supply configured to provide HFAC electrical energy to the HFAC power supply bus and having power supply output terminals for coupling to said bus;
a protection circuit connected to the power supply output terminals and being arranged to provide a short circuit of the power supply, for example between output terminals of conversion circuitry of the power supply;
a power supply inhibitor operable to disable the power supply to prevent the provision of electrical energy;
a detector circuit, configured to monitor gamma radiation to provide a detection signal; and
a controller configured to operate the power supply inhibitor to prevent the provision of electrical energy in the event that the detection signal exceeds a threshold and then subsequently to operate the protection circuit to provide the short circuit.

The detector circuit may be operable to detect electromagnetic pulses having a rise time of less than 50 nanoseconds, for example less than 10 nanoseconds.

The detector circuit may comprise a PIN diode, and the detector circuit may be configured to detect the electromagnetic field pulses based on a conduction state of the PIN diode.

The protection circuit may comprise an electronic crowbar.

The controller may be configured to operate the protection circuit to remove the short circuit prior to operating the power supply inhibitor to reenable the provision of electrical energy by the power supply.

The controller may be configured to operate the protection circuit to remove the short circuit at least 100 ms, for example at last 500 ms after operating the power supply inhibitor.

The HFAC power supply may comprise an active element configured to drive an inductive circuit to oscillate to provide said HFAC electrical energy, and the power supply inhibitor may be configured to disable said active element.

The controller may be configured to provide a control signal to protect at least one further electronic device connected to be powered by the HFAC bus.

The control signal may be configured to disconnect said at least one further electronic device from the bus and/or to provide a short-circuit or otherwise to disable said at least one further electronic device.

An aspect of the disclosure provides an electronic devices comprising a circuit board, the circuit board comprising:
a high frequency alternating current (HFAC) power distribution bus comprising a pair of electrical conduction paths embedded in the circuit board and for connection to an HFAC power supply, wherein the HFAC power distribution bus is arranged for supplying HFAC electrical energy from the HFAC power supply for powering electrical components carried by the circuit board;
a protection circuit connected between the pair of electrical conduction paths and being operable to provide a short circuit between the pair of electrical conduction paths;
a power supply inhibitor operable to provide a signal to the HFAC power supply to disable the power supply and prevent the provision of electrical energy to the bus;
a detector circuit, configured to monitor gamma radiation to provide a detection signal; and
a controller configured to operate the power supply inhibitor to prevent the provision of electrical energy in the event that the detection signal exceeds a threshold and then subsequently to operate the protection circuit to provide the short circuit.

This device may further comprise the HFAC power supply, which may be made and sold separately.

The detector circuit may be operable to detect electromagnetic field pulses having a rise time of less than 10 nanoseconds. The detector circuit comprises a PIN diode, and the detector circuit is configured to detect the gamma ray pulses based on a conduction state of the PIN diode. The protection circuit may comprise an electronic crowbar.

The controller may be configured to operate the protection circuit to remove the short circuit prior to operating the power supply inhibitor to reenable the provision of electrical energy by the power supply.

The controller may be configured to operate the protection circuit to remove the short circuit within 500 ms after operating the power supply inhibitor.

The HFAC power supply may comprise an active element configured to drive an inductive circuit to oscillate to provide said HFAC electrical energy, and the power supply inhibitor is configured to disable said active element.

The detection signals described herein may be based on sensing low frequency, such as DC, current in an alternating current, AC, supply to the HFAC power supply. For example, typically the HFAC power supply may be supplied by a mains AC supply of 50 Hz or 60 Hz or a similar appropriate main AC frequency. A detector circuit may be configured to detect presence of a low frequency current, such as DC current, in the mains supply and provide a detection signal to the controller on this basis. Examples of such low frequency current include a low frequency current, such as DC current, between an AC neutral line and ground. Examples of such low frequency current DC current in the neutral line of the AC supply.

In examples, the low frequency signals comprise frequencies less than 0.5 Hz, for example less than 0.1 Hz.

### BRIEF DESCRIPTION OF DRAWINGS

Embodiments of the disclosure will now be described in detail with reference to the accompanying drawings, in which:

FIG. 1 shows high frequency alternating current (HFAC) power distribution system according to the present disclosure;

FIG. 2 shows an electronic device comprising a circuit board according to the present disclosure;

FIG. 3 illustrates a detector circuit suitable for use in systems such as those shown in FIG. 1 and electronic devices such as those shown in FIG. 2.

In the drawings like reference numerals are used to indicate like elements.

### SPECIFIC DESCRIPTION

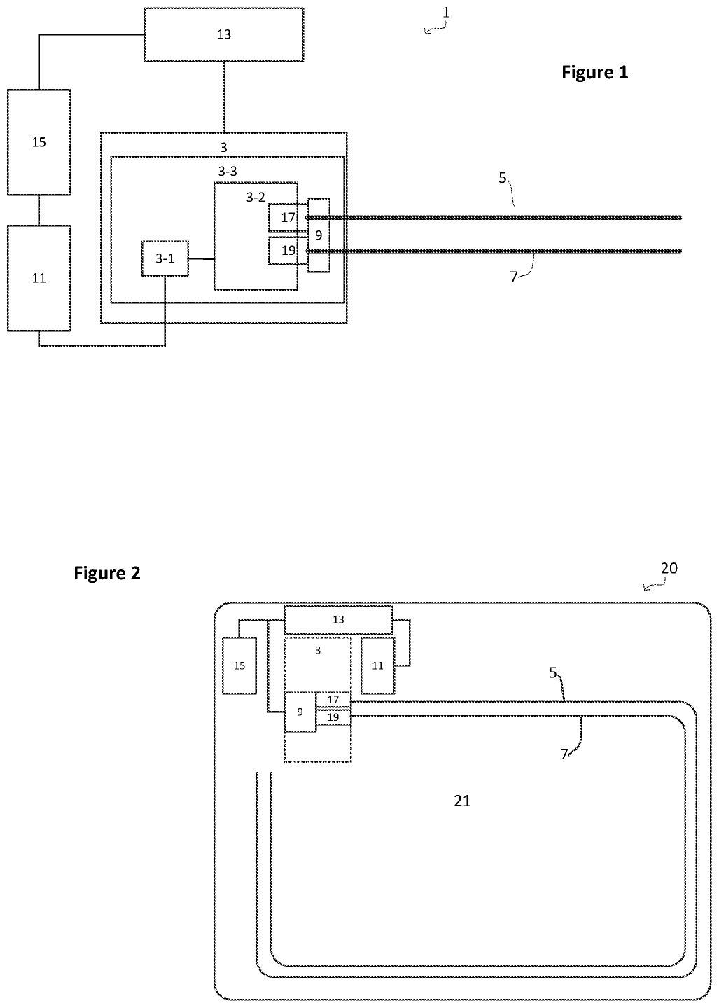

FIG. 1 shows a high frequency alternating current (HFAC) power distribution system 1. The system 1 comprises an HFAC power supply 3, an HFAC power supply bus 5, 7, a protection circuit 9, a power supply inhibitor 11, a detector circuit 13, and a controller 15.

This arrangement is configured so that, in response to the detector circuit 13 detecting an EMP event, the controller 15 operates the power supply inhibitor to switch off the power conversion circuitry in the power supply 3 and then subsequently operates the protection circuit 9 to short circuit the output terminals 17, 19 of the conversion circuitry. The details of this arrangement will now be described.

The HFAC power supply bus 5, 7 comprises a pair of conductors, such as wires or tracks, which when the system is in use operate to distribute a supply of HFAC power. In particular, the bus 5, 7 is arranged so that devices to be powered by the system can be arranged spaced apart along the bus 5, 7. In this arrangement, each of the devices can draw power from the bus simultaneously. Depending on the mode of operation of the power supply 3, the devices may be either:
(a) electrically connected to both of the two conductors of the bus (i.e. electrically between the two conductors) so that any voltage between the two conductors is applied across the device's connections to the bus for powering the device, or
(b) inductively coupled to at least one of the two conductors so that the HFAC current in the bus induces a corresponding current in the device for powering the device.

It will thus be appreciated that the bus 5, 7 serves for the distribution of power from the power supply to a plurality of devices coupled to the bus at a variety of locations spaced apart along the length of the bus.

The HFAC power supply 3 comprises conversion circuitry 3-3 which has two output terminals 17, 19, each of which is coupled for supplying power to a corresponding one of the two conductors 5, 7 which make up the HFAC power supply bus.

The controller 15 is connected to the detector circuit 13, the power supply inhibitor 11, and to the protection circuit 9. The power supply inhibitor 11 is connected to the power supply 3, and the protection circuit 9 is connected to the output terminals 17, 19 of the power supply.

The HFAC power supply 3 typically also comprises a source of electrical energy (not shown) such as a connection to a source of DC current or AC current and or an appropriate converter. The conversion circuitry 3-3 is connectable to be powered by such a source and comprises an active element 3-1 and inductive elements 3-2 such as a transformer which can be driven to oscillate by the active element 3-2 to provide an HFAC signal at the output terminals 17, 19. Other types of power supply may be used. The power supply inhibitor 11 is arranged so that, when it is triggered, the power supply is unable to provide electrical energy to the output terminals 17, 19. For example, this may be achieved by disabling the active element 3-2, e.g. by grounding an enable pin or similar.

Regardless of the type of power supply, the protection circuit 9 is electrically connected to the output terminals 17, 19 and can be operated to provide a short circuit between those terminals. Most often the protection circuit 9 will be provided by a crowbar circuit which, when triggered, shorts the terminals together and will not remove the short circuit until actively caused to do so—e.g. by the provision of a control signal from the controller 15.

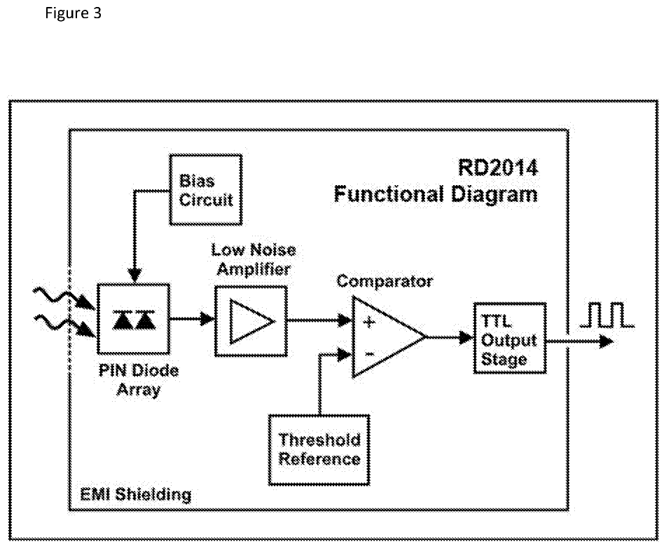

The detector circuit 13 comprises a gamma ray detector to provide a suprathreshold detection signal in the event that it detects a sufficient gamma dose rate to indicate an EMP event. Typically the detection circuit is configured to detect pulses of gamma rays, which may have a pulse rate of less than 50 nanoseconds, for example less than 10 nanoseconds. It may be triggered to provide the detection signal in response to a gamma dose rate of at least 1000 Gray per second (Gy·s⁻¹), for example at least 1*10⁴ Gy·s⁻¹, for example at least 1*10⁵ Gy·s⁻¹, for example at least 1*10⁷ Gy·s⁻¹. An example of one suitable detection circuit is illustrated in FIG. 3.

The controller 15 comprises logic circuits which are connected to the detector circuit for receiving the detection signal, and which are operable to provide control signals for operating the power supply inhibitor and the protection circuit. The controller logic is also configured so that, in the event that the detection signal exceeds a threshold, the controller 15 operates the power supply inhibitor immediately (typically within a response time of less than 100 ns, for example less than 50 ns). The controller's logic is further configured so that, immediately after this has been done, it provides a control signal to operate the protection circuit to short circuit the output terminals 17, 19 of the conversion circuitry 3-3.

In general operation, the power supply 3 typically operates to supply HFAC electrical energy along the bus (e.g. by driving an oscillator circuit within the power supply or otherwise). The devices distributed along the bus draw power from the bus for their own operation. The power supply may respond to the load on the bus associated with power drawn by these devices, e.g. to ensure that parameters of the supply of power (e.g. voltage, and/or current and/or frequency) stay within predefined limits. These limits may be selected according to the devices which are to be powered so that, when supplied with HFAC via the bus, the devices can continue to operate properly. During the supply of power to these devices, the detector circuit monitors gamma rays in the vicinity of the power supply unit and, in the event that it detects gamma rays having characteristics of an EMP it provides a suprathreshold detection signal to the controller. The controller responds to this detection signal, as outlined above, by first triggering the power supply inhibitor and then triggering the protection circuit. When the power supply inhibitor is triggered, the active supply of power to the output terminals ceases (e.g. because the means by which energy from the source is provided to the terminals is itself disabled). Accordingly, the controller then operates the protection circuit to short circuit the output terminals 17, 19, which protects the power supply from excessive electrical energy which might otherwise arise from inductive coupling between the EMP event and the HFAC bus. This may also protect any additional devices connected to the HFAC bus 5, 7, such as any further converters downstream of the power supply. Examples of such devices may include power conversion circuits, such as HFAC to DC, DC to HFAC, HFAC to LFAC converters and other converters.

This power supply system 1 may be used in any system in which an HFAC power supply is used to supply power along an HFAC bus which distributes electrical power to a plurality of devices along that bus. One particularly advantageous implementation is now described with reference to FIG. 2.

FIG. 2 shows an electronic device 20 comprising a circuit board 21, such as might be used to provide a motherboard or other circuit board in a computing device.

Components such as individual components and/or devices and/or daughter boards connected to such a circuit board 21 may serve to carry out a variety of functions (e.g. data processing, memory storage, graphics processing, temperature control and so forth). In addition to such circuitry being connected together on the board for performing these and other functions, it also requires a supply of electrical power. For this purpose, the circuit board 21 of FIG. 2 comprises a high frequency alternating current (HFAC) power distribution bus 5, 7. This serves the same purpose as the bus 5, 7 described above with reference to FIG. 1. In the embodiment of FIG. 2, the bus 5, 7 is provided by a pair of electrical conduction paths which are embedded in the circuit board 21. These electrical conduction paths may be provided by metallization in one more layers of the circuit board (e.g. copper tracks patterned into one or more of the layers of the board and/or separated by intervening layer(s) of dielectric in the board). These conduction paths are arranged for supplying HFAC electrical energy to power the electrical components carried by the circuit board.

The circuit board 21 also comprises a connector for connection of the HFAC bus 5, 7 to an HFAC power supply 3.

In the embodiment shown in FIG. 2 a protection circuit 9 is electrically connected between the pair of electrical conduction paths and, like the protection circuit described above with reference to FIG. 1, is operable to provide a short circuit between the pair of electrical conduction paths 5, 7.

A power supply inhibitor 11 is also provided, having the same functionality as that described above with reference to FIG. 1. Accordingly, the power supply inhibitor 11 is operable to disable the HFAC output from the power supply. For example, this may be achieved by disabling the power supply and prevent the provision of electrical energy to the bus.

Just as in FIG. 1, the detector circuit 13 is configured to monitor gamma dose rate and to provide a detection signal to the controller. The controller comprises logic circuits which are connected to the detector circuit for receiving a detection signal. These logic circuits are also connected to the power supply inhibitor and to the protection circuit.

The controller's logic is configured to prevent the provision of electrical energy in the event that the detection signal exceeds a threshold and then subsequently to operate the protection circuit to provide the short circuit between the pair of electrical conduction paths.

The operation of this device proceeds as described above with reference to FIG. 1.

It will be appreciated in the context of the present disclosure that the circuit board may be a multi-layer PCB. Such circuit boards may be suitable for use as motherboards for computing devices. The bus may be sandwiched between ground planes in the PCB. For example, a first ground plane and a second ground plane may be provided by layers disposed in the dielectric substrate which makes up the board. The two ground planes may be separate layers of a multi-layered structure, with the bus provided between them. The HFAC power distribution buses described and claimed herein may each comprise a pair of electrical conduction paths which may be matched so as to provide two conduction paths of equal path length from the HFAC power supply terminals to each component or device which is to be powered by the bus. This may be particularly useful when the power supply is configured to operate in a constant voltage mode (e.g. when components or devices are to be electrically connected between the two conduction paths of the bus. In other words, the two paths may be configured so that the signal on each conduction path remains in phase with that on the other conduction path at the point electrical power is taken from the bus, e.g. at a connection to a component or device. The path length may comprise the path length from the power supply connection to an input connection for powering the component or device. The two conduction paths may be spatially aligned with each other. For example they may comprise elongate conductive members disposed parallel to each other. Aligning the electrical conduction paths may reduce an effective H-field generated around said conduction paths when current (e.g. HFAC) flows through said conduction paths in use.

The electronic device may comprise an HFAC power supply connected to the power supply connection. In use, the H-field generated by the first HFAC power distribution bus is reduced by the pair of electrical conduction paths being aligned with each other.

It will be appreciated in the context of the present disclosure that the power supply may be made and sold separately in which case the power supply inhibitor may be provided, at least partially, in the HFAC power supply. For example, the power supply inhibitor carried on the board may comprise a signal connection for connecting to an interruption circuit of the power supply—for example to provide a control signal to ground an enable pin of an active element of the power supply.

A variety of different detector circuits may be used for detecting the gamma dose rate provided that the circuit is able to detect gamma dose rates of at least 1*10³ Gy·s⁻¹ One example of a detector circuit is illustrated in FIG. 3. It can be seen that this circuit comprises a PIN diode. The detector circuit illustrated in FIG. 3 operates the pin diode in a forward biased state—e.g. at constant current. An amplifier may be connected to the pin diode for sensing the voltage across it. The arrival of radiation associated with an EMP triggers the generation of charge carriers in the depletion region of the PIN diode. This causes a change in the conduction state of the PIN diode and so a change in the voltage across it. Circuits of this type, and other such circuits, are suitable for providing detection signals quickly enough to meet the response time requirements of embodiments of the present disclosure.

Any feature of any one of the examples disclosed herein may be combined with any selected features of any of the other examples described herein. For example, features of methods may be implemented in suitably configured hardware, and the configuration of the specific hardware described herein may be employed in methods implemented using other hardware.

It will be appreciated in the context of the present disclosure that by HFAC power supply, what is meant is a power supply having a frequency of at least 900 kHz, for example at least 1 MHz, for example less than 5 MHz, for example less than 3 MHz, for example between about 1 MHz and about 2 MHz.

In an aspect there is provided a high frequency alternating current (HFAC) power distribution system configured to provide an HFAC power supply on an HFAC power supply bus to enable a plurality of electronic devices to be connected to the power supply bus for receiving HFAC electrical energy, the power distribution system comprising:
an HFAC power supply configured to provide HFAC electrical energy to the HFAC power supply bus and having power supply output terminals for coupling to said bus;
   a power supply inhibitor operable to disable the power conversion circuits within the power supply to prevent the provision of electrical energy;
a protection circuit connected to the various power conversion circuits in the power supply (AC to DC, DC to DC and DC to AC) and being arranged to provide a short circuit between the outputs of said power conversion circuits.

The system may also comprise a detector circuit, configured to monitor gamma rays to provide a detection signal; and
a controller configured to operate the power supply inhibitor to prevent the provision of electrical energy in the event that the detection signal exceeds a threshold and then subsequently to operate the protection circuit to provide the short circuit between the outputs of the power conversion circuits within the power supply output terminals;
   a control signal from the detector circuit to transmit a detected event to downstream power conversion circuits, such as HFAC to DC, DC to HFAC, HFAC to LFAC;
   a timer circuit to release any electronic crowbars and release any inhibitors to allow the power supply to restart safely.

The detector circuit may be operable to detect electromagnetic pulses having a rise time of less than 50 nanoseconds, for example less than 10 nanoseconds.

The controller may be configured to operate the protection circuit to remove the short circuit at least 100 ms, for example at least 500 ms after operating the power supply inhibitor.

An aspect of the disclosure also provides an electronic device comprising a circuit board, the circuit board comprising:
a high frequency alternating current (HFAC) power distribution bus comprising a pair of electrical conduction paths embedded in the circuit board and for connection to an HFAC power supply, wherein the HFAC power distribution bus is arranged for supplying HFAC electrical energy from the HFAC power supply for powering electrical components carried by the circuit board;
   a control signal from the detector circuit to transmit a detected event to downstream power conversion circuits, such as HFAC to DC, DC to HFAC, HFAC to LFAC;
a protection circuit connected between the outputs of internal power conversion circuits and being operable to provide a short circuit between the outputs;
a power supply inhibitor operable to provide a signal to the HFAC power supply internal power conversion circuits to disable the power supplies and prevent the provision of electrical energy to the bus;
a detector circuit, configured to monitor gamma rays to provide a detection signal; and
a controller configured to operate the power supply inhibitor to prevent the provision of electrical energy, in the event that the detection signal exceeds a threshold and then subsequently to operate the protection circuit to provide the short circuit between the outputs of power conversion circuits.

It will be appreciated from the discussion above that the embodiments shown in the Figures are merely exemplary, and include features which may be generalised, removed or replaced as described herein and as set out in the claims. With reference to the drawings in general, it will be appreciated that schematic functional block diagrams are used to indicate functionality of systems and apparatus described herein.

It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

In some examples the functionality of the controller may be provided by a general purpose processor, which may be configured to perform a method according to any one of those described herein. In some examples the controller may comprise digital logic, such as field programmable gate arrays, FPGA, application specific integrated circuits, ASIC, a digital signal processor, DSP, or by any other appropriate hardware. In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein. The controller may comprise an analogue control circuit which provides at least a part of this control functionality. An embodiment provides an analogue control circuit configured to perform any one or more of the methods and/or logic operations described herein.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A high frequency alternating current ( HFAC) power distribution system configured to provide an HFAC power supply on an HFAC power supply bus to enable a plurality of electronic devices to be connected to the power supply bus for receiving HFAC electrical energy, the power distribution system comprising:
an HFAC power supply configured to provide HFAC electrical energy to the HFAC power supply bus and having power supply output terminals for coupling to said bus;
a protection circuit connected to the power supply and being arranged to provide a short circuit of the power supply;
a power supply inhibitor operable to disable the power supply to prevent the provision of electrical energy;
a detector circuit, configured to monitor gamma radiation to provide a detection signal; and
a controller configured to operate the power supply inhibitor to prevent the provision of electrical energy in the event that the detection signal exceeds a threshold and then subsequently to operate the protection circuit to provide the short circuit.

2. The system of claim 1 wherein the detector circuit is operable to detect a gamma dose of at least 1*10³ Gy·s⁻¹.

3. The system of claim 2 wherein the detector circuit comprises a PIN diode, and the detector circuit is configured to detect the electromagnetic field pulses based on a conduction state of the PIN diode.

4. The system of any preceding claim wherein the protection circuit comprises an electronic crowbar.

5. The system of any preceding claim wherein the controller is configured to operate the protection circuit to remove the short circuit prior to operating the power supply inhibitor to reenable the provision of electrical energy by the power supply.

6. The system of claim 5 wherein the wherein the controller is configured to operate the protection circuit to remove the short circuit within 500 mS after operating the power supply inhibitor.

7. The electronic device of any preceding claim wherein the HFAC power supply comprises an active element configured to drive an inductive circuit to oscillate to provide said HFAC electrical energy, and the power supply inhibitor is configured to disable said active element.

8. An electronic device comprising a circuit board, the circuit board comprising:
a high frequency alternating current (HFAC) power distribution bus comprising a pair of electrical conduction paths embedded in the circuit board and for connection to an HFAC power supply, wherein the HFAC power distribution bus is arranged for supplying HFAC electrical energy from the HFAC power supply for powering electrical components carried by the circuit board;
a protection circuit connected between the pair of electrical conduction paths and being operable to provide a short circuit between the pair of electrical conduction paths;
a power supply inhibitor operable to provide a signal to the HFAC power supply to disable the power supply and prevent the provision of electrical energy to the bus;
a detector circuit, configured to monitor gamma radiation to provide a detection signal; and
a controller configured to operate the power supply inhibitor to prevent the provision of electrical energy in the event that the detection signal exceeds a threshold and then subsequently to operate the protection circuit to provide the short circuit.

9. The electronic device of claim 8 further comprising the HFAC power supply.

10. The electronic device of claim 9 wherein the power supply inhibitor is provided in the HFAC power supply.

11. The electronic device of claim 8, 9 or 10 wherein the detector circuit is operable to detect a gamma dose rate of at least 1*10³ Gy·s⁻¹.

12. The electronic device of claim 11 wherein the detector circuit comprises a PIN diode, and the detector circuit is configured to detect the electromagnetic field pulses based on a conduction state of the PIN diode.

13. The electronic device of any of claims 8 to 12 wherein the protection circuit comprises an electronic crowbar.

14. The electronic device of any of claims 8 to 13 wherein the controller is configured to operate the protection circuit to remove the short circuit prior to operating the power supply inhibitor to reenable the provision of electrical energy by the power supply.

15. The electronic device of claim 14 wherein the wherein the controller is configured to operate the protection circuit to remove the short circuit a predetermined time after operating the power supply inhibitor, for example within 3 seconds, for example within 1 second, for example within 500 ms.

16. The electronic device of any preceding claim wherein the detection signal is further based on sensing low frequency current in an alternating current, AC, supply to the HFAC power supply.

17. The electronic device of any of claims 8 to 16 wherein the HFAC power supply comprises an active element configured to drive an inductive circuit to oscillate to provide said HFAC electrical energy, and the power supply inhibitor is configured to disable said active element.

18. The electronic device of any of claims 8 to 16 wherein the controller is configured to provide a control signal to protect at least one further electronic device connected to be powered by the HFAC bus.

19. The electronic device of claim 18 wherein the control signal is configured to disconnect said at least one further electronic device from the bus and/or to provide a short-circuit or otherwise to disable said at least one further electronic device.

20. An apparatus comprising the electronic device of claim 18 or 19 and said at least one further electronic device.
